(19) United States
(12) Patent Application Publication
(10) Pub. No.: US 2012/0097322 A1
(43) Pub. Date: Apr. 26, 2012

(54) METHOD FOR CLADDING COMPONENT WITH SELF-SUPPORTING CLADDING CLOSED BY COLD SPRAYING

(75) Inventors: Uwe Pyritz, Berlin (DE); Oliver Stier, Berlin (DE)

(73) Assignee: SIEMENS AKTIENGESELLSCHAFT, MUNICH (DE)

(21) Appl. No.: 13/381,753

(22) PCT Filed: Jun. 10, 2010
(86) PCT No.: PCT/EP2010/058127

§ 371 Date: Dec. 30, 2011

(30) Foreign Application Priority Data
Jun. 30, 2009 (DE) 10 2009 031 575.6

(51) Int. Cl. B32B 37/02; B32B 37/14; B32B 37/12

(52) U.S. Cl. 156/185

(57) ABSTRACT

Cladding that is self-supporting is joined on a component such that a joining gap is created between the edges. The joining gap is closed by cold gas spraying with a bead-like layer such that the cladding can be used, for example, as corrosion protection. If the component is made of aluminum, for example, the component can be sued as a current-conducting component during galvanic coating. In this case, a cladding made of titanium can be used as the corrosion protection layer.

### CROSS REFERENCE TO RELATED APPLICATIONS

This application is the U.S. national stage of International Application No. PCT/EP2010/058127, filed Jun. 10, 2010 and claims the benefit thereof. The International Application claims the benefits of German Application No. 102009031575.6 filed on Jun. 30, 2009, both applications are incorporated by reference herein in their entirety.

### BACKGROUND

Described below is a method for cladding a component with a self-supporting cladding.

Claddings can be applied to components in order to improve the functionality thereof. In this respect, it is known, for example, that in the case of components a cladding can be produced from flat products which can be suitably deformed. By way of example, these claddings can be used for current-carrying structures for the galvanic coating of components. Such a component can form a holder for the components to be coated, for example. In order to make electrical contact therewith in the electrochemical coating bath, the component holder has to be electrically conductive. To this end, it is desired to use good conductors such as copper or aluminum. In order to protect these metals against electrochemical dissolution, a cladding made of titanium is applied to the component, extending at least over that part of the component which is immersed in the electrolyte.

It is known in principle from US 2006/0113359 A1 that it is possible to connect current-carrying components to one another by cold spraying. For this purpose, these electrical components, for example an electrical device and the metallic surface of a printed circuit board, are aligned with one another in the desired position and electrically conductively connected to one another by the application of material by cold spraying. These connections can be established with an electrical resistance of less than 0.5 mΩ.

### SUMMARY

An aspect is to specify a method for cladding components with which it is possible to produce claddings with a relatively good protective action in a relatively cost-effective manner.

This is achieved by a method for cladding a component in which the component is firstly inserted into a self-supporting cladding made of a cladding material. The cladding is then joined together and/or deformed such that two edges of the cladding abut against one another, are aligned with one another or overlap one another to form a joining gap. Within this context, “joining” is to be understood as meaning all handling steps during production which make it possible to form the joining gap. This can be effected by handling pre-shaped parts, which have a corresponding fit, such that an abutting edge or overlapping arises as a result of the joining process to form the joining gap. However, it is also possible, after the component has been inserted, to plastically deform the cladding material, as a result of which the component is embedded and the edges of the cladding form an abutment or an overlap to form the joining gap. For this purpose, the cladding material can be an areal semi-finished product, for example a thin metal sheet. The joining gap can have a width of 0 to 5 mm, such as approximately 2 mm. As a result, it is advantageously possible to compensate for manufacturing tolerances.

Finally, the joining gap is closed by applying a layer which bridges the joining gap by cold spraying. This is advantageously a method with which relatively thick layers can be produced in a short time. In addition, if the procedure is suitable, it is possible for the layer material to be applied as a coating under atmospheric conditions, making cost-effective coating possible. The main advantage of cold spraying, however, is that the cold gas jet which applies the particulate layer material does not melt the cladding material, but instead the particles, on account of their kinetic energy, produce the layer and the adhesion thereof to the cladding material on account of plastic deformation. In this case, it is advantageous that only the surface of the cladding material is attacked, as a result of which the good layer adhesion is achieved. It is possible, however, to preclude melting of regions of the cladding material which are remote from the surface. In contrast, for example, to welding of the joining gap, it is therefore advantageously possible to work with smaller wall thicknesses of the cladding material, since it is not necessary to dissipate heat from welding energy into the cladding material. The actual task of the cladding is therefore to be seen as the significant factor for the chosen wall thickness thereof. If, by way of example, the cladding is used as corrosion protection for metallic components which are used for electrochemical coating, the wall thicknesses which are required for the formation of reliable corrosion protection given the selection of, for example, titanium or a titanium alloy for the cladding would be considerably thinner than those which would have to be present for welding the cladding. Compared to welded claddings, it is therefore possible to save cladding material in the case of claddings which are sealed by cold spraying. On account of the demands made on the cladding, this material is often more expensive than the material of the component to be clad, and therefore smaller wall thicknesses of the cladding advantageously lead to more economical components.

According to one configuration, the layer which is applied by the cold spraying is formed from a metal. Most metals can advantageously be deposited simply by cold spraying, since the plastic deformation behavior thereof is beneficial to the layer structure. In particular, it is possible to select a metal or a metal alloy which corresponds to the cladding, for example a titanium alloy or titanium. This has the advantageous effect that, in the event of corrosive attack, for example, the electrochemical behavior of the layer is largely adapted to the electrochemical behavior of the cladding material, or if identical materials are chosen, the corrosion behavior is even identical. As a result, it is possible to prevent the formation of local elements at the layer edge, and this is why uniform corrosion of the cladding material occurs even in the region of the joining gap. The alloy of the layer material can advantageously be set here by a suitable powder mixture of the particles used for coating, the alloy then being formed during the layer build-up. Alternatively, it is of course also possible to use particles which are formed of the alloy in question.

For using the cladding as corrosion protection, it is particularly advantageous if the layer is applied with a thickness which is sufficient for the layer to be impermeable to ions. Particularly in electrochemical processes, it is thereby advantageously possible to prevent ions from migrating through the layer and then through the joining gap and the possible resultant creation of corrosion of the clad component. In this respect, it should be taken into consideration that, on account of their charge, the impermeability to ions satisfies higher demands than sealing with respect to uncharged chemical substances. If the layer is produced from a metallic material, it is possible to achieve permeability to ions even with relatively small layer thicknesses. The thickness of the cladding material can advantageously be at most 1 mm, it being desirable to use the cladding material with a thickness of 100 to 300 μm, it also being possible to consider a removal rate on account of corrosive attack of the cladding over the intended service life of the clad component.

It is particularly advantageous if the layer is produced at least above the joining gap in a thickness which is greater than or equal to the thickness of the cladding material. If the cladding material is formed with a suitable thickness, taking its function into consideration, a layer in the region of the joining gap which is greater than or equal to the thickness of the cladding material can advantageously ensure that the demands made on the cladding material are likewise satisfied in this region. Outside the joining gap, a smaller thickness of the layer can be provided. In particular, it is advantageous if the layer is produced in the form of a bead on the joining gap, the greatest thickness of which bead lies precisely over the joining gap, whereas, toward either side of the cladding, the layer thickness decreases and thus forms a transition between the layer and the surface of the cladding.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a section through a component which has been produced according to an exemplary embodiment of the method,

FIG. 2 is a perspective view of an exemplary embodiment of a portion of a component being produced according to an exemplary embodiment of the method in which cold spraying is used, and

FIG. 3 is a plan view of a component which was produced according to an exemplary embodiment of the method.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

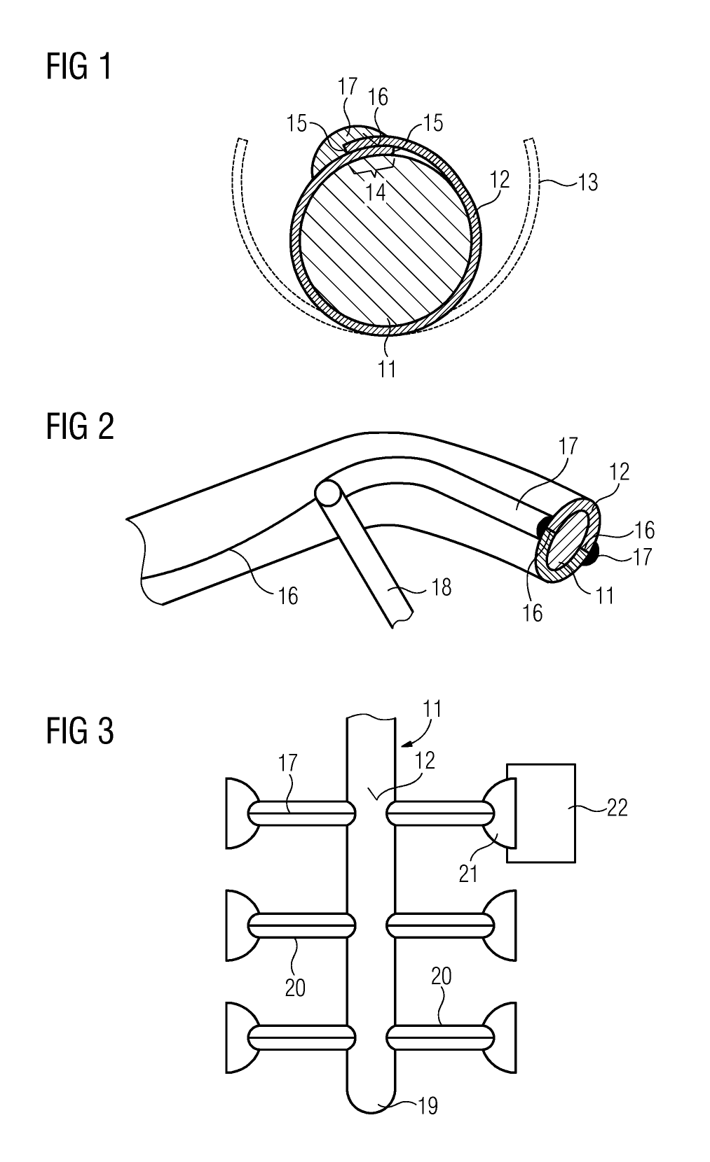

A component 11 as shown in FIG. 1 can be in the form of a rod, which is shown in section in FIG. 1. The component is provided with a cladding 12, which has been bent from a metal sheet. The bending of the metal sheet involves two steps. In a first step, the metal sheet is bent until it has a sufficiently wide gap for the insertion of the component 11 (see the contour 13 illustrated by dashed lines).

After the component 11 has been inserted, the metal sheet is closed, with the formation of an overlapping region 14. A joining gap 16 is formed within this overlapping region between the edges 15 of the cladding, and has to be sealed. This is done using a bead-shaped layer 17, which covers the joining gap 16 and the adjoining edge regions at the edges 13 of the cladding and thus leads to hermetic sealing, impermeable to ions, of the cladding 12.

The cladding 12 shown in FIG. 2 is of double-shell design, the section through the component 11 illustrated showing the two joining gaps 16 beneath the bead-shaped layer 17 which split the cladding 12 into two half-shells. If the thickness of the cladding is 100 to 300 μm, the gap widths can be between 0 and 5 mm, such as approximately 2 mm. The edges of the cladding can be beveled (not shown), such that the gap width reduces toward the component. If the gap width is greater than 0 mm, the cladding is also advantageously fixed on the component by the bead. FIG. 2 also shows how the bead-shaped layer 17 is applied in a straight manner to the joining gap 16 by a cold gas jet 18. The latter includes coating particles which impinge upon the surface of the cladding 12 at high speed and produce the layer 17 by plastic deformation (not shown). It becomes clear that three-dimensional spatial curves of the joining gap 16 can also be coated by the cold gas jet 18 by suitable guidance. Specifically, the component 11 is bent such that the line of the joining gap 16 also does not run rectilinearly.

FIG. 3 shows a holding apparatus as the component 11. The apparatus has a trunk 19, from which branches 20 having clamping apparatuses 21 for components 22 to be coated branch off. The entire component 11 (i.e. the trunk, the branches and the clamping apparatus) is clad. The bead-shaped layer 17 is indicated on the branches 20. The trunk is clad with two half-shells, the joining gaps of which lie parallel to the plane of the drawing and therefore cannot be seen in FIG. 3. The component 11 can be used for immersing the components 22 to be coated in an electrolyte (not shown). That end of the component 11 which is not shown is provided with an apparatus for receiving an electrical line, such that the component can be connected as electrode and an electrically conductive connection is thereby established with the components 22 to be coated. In order to ensure electrical conductivity, the component 11 is produced from aluminum and the cladding 12 is titanium. The layer 17 is also produced from titanium. The cladding made of titanium thus forms effective corrosion protection for the component made of aluminum even under the corrosive conditions as prevail during the galvanic coating of components.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A method for cladding a component, comprising:
inserting the component into a self-supporting cladding made of a cladding material having a thickness of at most 1 mm;
joining and/or deforming the cladding until two edges of the cladding abut against one another, are aligned with one another or overlap one another to form a joining gap; and
applying a layer by cold spraying until the layer bridges and closes the joining gap, the layer above the joining gap having a layer thickness at least as thick as the cladding material.

10. The method as claimed in claim 9, wherein the cladding material has a cladding thickness of 100 to 300 μm.

11. The method as claimed in claim 10, wherein the cladding is formed from a metal.

12. The method as claimed in claim 11, wherein the cladding is formed from one of titanium and a titanium alloy.

13. The method as claimed in claim 12, wherein the layer is formed from a metal.

14. The method as claimed in claim 13, wherein the layer is formed of the cladding material.

15. The method as claimed in claim 14, wherein the layer thickness is sufficient for the layer to be impermeable to ions.

16. The method as claimed in claim 15, wherein the layer is produced as a bead which follows the joining gap.

17. The method as claimed in claim 16, wherein the cladding serves as corrosion protection for the component.

18. The method as claimed in claim 17, wherein the component is a metallic component for electrochemical coating.

19. The method as claimed in claim 18, wherein the component is formed from a component material selected from the group consisting of copper, aluminum, a copper alloy and an aluminum alloy.
